(19) United States
(12) Patent Application Publication
(10) Pub. No.: US 2002/0116563 A1
(43) Pub. Date: Aug. 22, 2002

(54) Apparatus and method to reduce interrupt latency in shared interrupt systems

(76) Inventor: Paul D. Lever, Edmonds, WA (US)

Correspondence Address: LAW OFFICES OF RONALD M ANDERSON, 600 108TH AVE, NE, SUITE 507, BELLEVUE, WA, 98004, US

(21) Appl. No.: 09/735,435

(22) Filed: Dec. 12, 2000

(51) Int. Cl. G06F 13/24

(52) U.S. Cl. 710/260

(57) ABSTRACT

Apparatus and a method for implementing prioritized interrupt handling of devices that assert interrupt requests on a shared interrupt request line. The method provides a scheme for handling interrupts in a computing apparatus having a plurality of devices that share a shared interrupt request line, such that interrupt servicing of a device among the plurality of devices that is selected to have a highest priority interrupts servicing of interrupt service routines for the other devices. Each device has a corresponding service routine that has a core service portion including instructions for servicing that device. In response to an assertion of a first interrupt request signal on the shared interrupt request line by one of the devices, the method determines the device that asserted the first interrupt request signal, and initiates execution of a core service portion of the service routine corresponding to the device determined to have asserted the first interrupt. In response to a subsequent assertion of an interrupt request signal by the highest priority device, execution of any currently executing service routine that corresponds to one of the other devices is interrupted. Conversely, a latter interrupt request from one of the other devices will not interrupt execution of the service routine corresponding to the highest priority device. By operating in this manner, the present invention reduces interrupt latencies for the highest priority device, and produces interrupt latencies that are more deterministic.

### FIELD OF THE INVENTION

The present invention generally concerns the handling of interrupts, and in particular, is directed to reducing interrupt latencies in a shared interrupt environment.

### BACKGROUND OF THE INVENTION

In an effort to improve the rate of data transfer between a microprocessor in a personal computer (PC) and peripheral devices, such as graphics cards and hard disk controllers, the Intel Corporation introduced a new computer bus architecture in 1992, called the peripheral component interconnect (PCI) bus. The PCI bus is a local bus system capable of moving 32 or 64 bits of data, currently at speeds up to 133 MHz. The PCI bus provides a wide, high-speed communication path that enables rapid transfer of data between the microprocessor and the peripheral devices, as well as faster access to other system resources, such as memory.

The majority of PC's currently in use support the PCI bus. In these computers, various peripheral devices may be connected to the PCI bus or via a PCI bus expansion slot (for use with add-on cards), or are directly integrated on the motherboard (such as graphic controllers and hard disk controllers). The processor communicates with the PCI peripheral devices through a special interface chipset, along with software drivers that are written with specific provisions for controlling the operation of each peripheral device. One of the most important features provided by the interface chipset is the handling of interrupts.

Since the introduction of the Intel Corporation 80286™ microprocessor in 1984, most PC's have employed the same limited interrupt scheme, which permits the use of only 15 prioritized maskable interrupts and one non-maskable interrupt, each corresponding to a separate interrupt request. As shown in FIG. 1, the majority of the maskable interrupts (values in the “INT (HEX)” column) are typically assigned to predefined interrupt requests (values in the “IRQ” column), for support of specific functions, such as the system timer, keyboard, serial ports, floppy disk controller, hard disk controller, mouse, etc. The remaining interrupt requests are available for assignment to add-on peripheral devices (or built-in devices), such as graphic cards, sound cards, etc.

In conjunction with the introduction of its AT computer, IBM expanded the PC bus architecture it used to provide support for 16-bit peripherals. This new bus, known as the industry standard architecture (ISA) bus (also called the “AT” bus), provided for separate interrupt request lines (i.e., pins) for each of the 15 maskable interrupts as well as a separate pin for the non-maskable interrupt. Generally, peripheral cards that are used with the ISA bus provide means for setting the card's interrupt request line so that several devices using different interrupt request lines can be attached to the ISA bus without creating an interrupt conflict, which would arise if two different devices were attempting to use the same interrupt.

In contrast to the ISA bus, the PCI bus specification (currently version 2.2, and all prior versions) only provides for four interrupt request lines, namely INTA, INTB, INTC, and INTD. In this specification, a single function peripheral device must use INTA as its default interrupt request, while multifunction peripheral devices preferably should use INTA to support their primary interrupt functions, and INTB through INTD as necessary, to support any other interrupt functions.

Many computers that employ PCI buses have adopted a “shared” or “wired-OR” interrupt binding architecture, which is typically implemented directly on the motherboard circuitry, i.e., the interrupt traces are routed in such a way as to provide for a shared interrupt scheme, as illustrated in FIG. 2. As recommended by the original PCI specification, interrupt pins INTA-INTD were supposed to be wired-OR on the motherboard. For example, on a system that provides four PCI expansion slots (SLOTS 1-4), pins 6 on side A of the expansion slot bus connectors (corresponding to INTA) are wired-OR'ed together, pins 7 on side B (corresponding to INTB) are wired-OR'ed together, etc. The effect of this scheme is that INTA may be shared if more than one board is installed in the PCI expansion slots, since the default (or primary) interrupt for a PCI board is INTA, as discussed above.

In order to reduce the likelihood of sharing, recent versions of the PCI specification require that the backplane (i.e., connector pin) interrupt pin assignments rotate through logical board slots to provide a unique PCI INTA interrupt to each board for the first four PCI connectors. A similar backplane requirement is also specified in the CompactPCI specification, which is an adaptation of the PCI specification for industrial and/or embedded applications requiring a more robust mechanical form factor than that provided by a typical desktop PC. An exemplary implementation of this scheme is shown in FIG. 3, which shows a table corresponding to the PCI interrupt routing used on motherboards that employ Intel Corporation's DK440LX™ chip set.

This routing scheme employs a PCI-to-ISA bridge (called the PIIX4 PCI-to-ISA bridge) that has four programmable interrupt request (PIRQ) input signals, PIRQA, PIRQB, PIRQC, and PIRQD. Any PCI interrupt source (i.e., any PCI device either mounted directly on the motherboard (an onboard device) or mounted on a PCI add-on card) connects to one of the PIRQ signals. Because there are only four signals, some PIC interrupt sources are electrically tied together on the motherboard and, therefore, share the same interrupt. FIG. 3 shows how the signals are connected to the PCI expansion slots and to onboard PCI interrupt sources. For example, assume an add-on card has one interrupt line (INTA) coupled to the second PCI slot (J1D1). In this slot, interrupt source INTA connects to the PIRQC signal, which is not connected to any onboard interrupt sources. If there are no other add-on cards, this card does not share its interrupt with any other devices.

If a second add-on card that has two devices (each respectively associated with one of two interrupts, INTA and INTB) is plugged into the first PCI slot (J1D2), INTA in the first slot is connected to signal PIRQB, and INTB is connected to signal PIRQC. Therefore, the second device on the two-function add-in card in the first slot will share its interrupt with the single-function card in the second slot, i.e., signal PIRQC will be shared. In addition, the first device on the two-function add-in card will share its interrupt with an on-board SCSI controller and a second device on a multi-function Accelerated Graphics Port (AGP) add-on card that is connected to a special PCI expansion slot that supports AGP devices.

In a typical PC, a PCI device requests an interrupt service by pulling one of its INTA-INTD pins low, which is known as “asserting” an interrupt request. The assertion of an interrupt request puts an INTA-INTD (or PIRQA-PIRQD) signal on the PCI bus, which is passed to a programmable interrupt controller (PIC) that is in communication with the PCI bus through a PCI-to-ISA bridge. Since a typical PC microprocessor can only process a single thread of instructions at a time, it is necessary to provide a way to handle multiple concurrent interrupts so that only a single interrupt request is presented to the microprocessor at a time. This task is performed by the PIC, as follows.

With reference to FIG. 4, PIC 10 receives a plurality of interrupt requests IRQ0-IRQ15, each corresponding to a particular priority order. Generally, the lower the IRQ, the higher the priority. In DOS-based systems and the original end-user and OEM released versions of Microsoft Corporation's WINDOWS 95™ operating system, each of the four PCI interrupt requests INTA-INTD are mapped to one of interrupt requests IRQ0-IRQ15 through the basic input output system (BIOS). In the Microsoft Corporation's WINDOWS 98™ and, WINDOWS 95™ OEM Release 2, the PCI interrupts can be “steered” to an available interrupt request. Upon receipt, an interrupt request is examined by an interrupt mask register 12 to determine if the interrupt is “masked.” A masked interrupt indicates that the interrupt should not be processed by the microprocessor. Interrupts can be masked by programming the PIC with a mask code using a data bus 13 and a control bus 15 in the computer.

If the interrupt request is not masked, it is forwarded to an interrupt request register 14. The interrupt request register stores all of the requested IRQs until they have been properly handled. In many instances, it is desirable to know if any interrupt requests are pending, which can be accomplished by reading the interrupt request register. This register is read by issuing an appropriate operation control word to the PIC.

A priority resolver 16 examines all of the pending interrupt requests (if any), and selects the IRQ with the highest priority to be serviced by the microprocessor, by sending an “INT” to the processor, i.e., by asserting the INT line on the processor. The processor will then complete the current instruction that it is processing and acknowledge the INT request by sending an Interrupt Acknowledge pulse on control bus 15.

Upon receiving the processors Interrupt Acknowledge pulse, the IRQ that the PIC is processing at the time is stored in an In-Service Register 18, which, as the name suggests, stores the IRQ that is currently in service. The IRQs bit is also reset in the Interrupt Request Register, as it is no longer a pending request, but instead, is actually being serviced.

Another Interrupt Acknowledge pulse will be sent by the processor, to tell the PIC to place an 8-bit pointer on data bus 13, corresponding to the IRQ number. The 8-bit pointer will cause the processor to “jump” to an address stored in an interrupt vector table that contains the beginning address of the operating system's exception code for handling the particular IRQ. The exception code will thus “jump” the processor to an interrupt handler, which comprises the interrupt and dispatch code for handling the interrupt request. The interrupt handler will then call appropriate service routines to service the interrupt request.

The exception code disables all (maskable) interrupts and calls an appropriate interrupt service routine (ISR) corresponding to the IRQ number, which is typically identified by reading the PIC. The ISR returns a logical interrupt in the form of an interrupt identifier, to the interrupt handler. The interrupt handler re-enables all interrupts, with the exception of the current interrupt, and signals execution of one or more ISRs corresponding to the logical interrupt. In Microsoft Corporation's WINDOWS 95™, WINDOWS 98™, and WINDOWS NT™ operating systems, an ISR is “registered” with the operating system when the PCI device's corresponding device driver is installed. For example, if three PCI devices share the same IRQ number, then three ISRs corresponding to that shared IRQ number (and corresponding logical interrupt) will be registered with the operating system. In instances where IRQs are shared, a list of ISRs will then be “walked” to first determine the device that requested interrupt service, and then to service the interrupt. This function is typically performed as each ISR by calls subroutines stored in the device driver to retrieve information by, e.g., reading the device registers. Depending on the order of execution of the ISRs, subsequent ISRs may have to be executed in order until the correct ISR is executed. When execution of the ISRs is completed (not all ISRs need to be called), the interrupt handler sends an End of Interrupt (EOI) signal over control bus 15 to the PIC, thereby resetting In-service Register 18. Preferably, at the same time, the IRQ corresponding to the interrupt level is unmasked at the PIC, so the subsequent pending interrupts at the same priority level can be serviced.

Many operating systems use a nested interrupt scheme that employs a hardware PIC or emulated PIC to determine priority levels for interrupts. The nested interrupt scheme allows ISRs corresponding to higher priority IRQs to interrupt a currently executing ISR corresponding to a lower priority IRQ. Conversely, an ISR corresponding to a lower or equal priority IRQ cannot interrupt the currently-executing ISR. In operating systems that do not support nested interrupts (e.g., versions of Microsoft Corporation's WINDOWS CE™ operating system prior to version 3.0), a currently executing ISR cannot be interrupted by an ISR corresponding to a higher priority IRQ; the current ISR must run to completion before any other interrupt requests can be serviced. Both of these interrupt schemes present a problem when using multiple PCI devices that share interrupts—any interrupt sharing device that requests interrupt service must wait for the completion of the handling of any currently-executing interrupt request prior to being serviced itself.

Under many circumstances, such as when a computer serves as a real-time control system, it is imperative that high-priority IRQs be serviced as quickly as possible. The time delay between an IRQ initially occurring and execution of the first instruction of the ISR by the processor is known as interrupt latency. In addition to minimizing interrupt latencies, it is also desired that interrupt latencies be deterministic (i.e., the time delay corresponding to the interrupt latency for a particular device under various operating conditions be predictable). Under conventional interrupt schemes, it is not possible to prioritize interrupt requests from PCI devices that share the same interrupt. This limitation leads to potentially long and indeterministic interrupt latencies. Therefore, it would clearly be advantageous to provide a method and system for enabling PCI devices that share the same interrupt to be prioritized so that higher priority interrupt requests from those devices are serviced as quickly as possible, reducing their interrupt latency. Furthermore, it is desired that such a scheme provide for deterministic interrupt latencies. The advantages of such a method and system in real-time control applications for computers will be readily apparent.

### SUMMARY OF THE INVENTION

In accord with the present invention, a method and apparatus are provided that address the foregoing limitations of the prior art by providing an interrupt handling scheme, which enables users to prioritize the handling of interrupt requests from peripheral devices that share an interrupt line. The method enables one device among a plurality of devices that share an interrupt line to be selected to have a highest priority, whereby interrupt requests asserted by this highest priority device may interrupt execution of service routines corresponding to earlier interrupt requests asserted by one of the non-selected devices. Conversely, a latter interrupt request from one of the non-selected devices will not interrupt execution of the service routine corresponding to the highest priority device.

According to a first aspect of the invention, a method is provided for handling interrupts in a computing apparatus having a plurality of peripheral devices that share a shared interrupt request line, where one device among the plurality of peripheral devices may be selected to have a higher priority than any of the remaining devices. Each peripheral device has a corresponding service routine that includes a core service portion that comprises instructions for servicing that peripheral device. In response to an assertion of a first interrupt request signal on the shared interrupt request line by one of the peripheral devices, the method determines the peripheral device that asserted the first interrupt signal, and dispatches execution of the core service portion of the service routine that corresponds to the peripheral device determined to have asserted the interrupt. The method also enables execution of the core service portion to be interrupted in response to a subsequent interrupt request signal that is asserted on the shared interrupt request line by the highest priority peripheral device, preferably by unmasking the shared interrupt request line. Preferably, this last step is only performed if the first interrupt request signal is not asserted by the highest priority device. This step prevents execution of the core service portion of the service routine corresponding to the highest priority device from being interrupted.

Under the foregoing conditions, execution of the service routine corresponding to the peripheral device that asserted the first interrupt request signal can be interrupted in response to a subsequent interrupt request signal asserted on the shared interrupt request line by the highest priority peripheral device. In response to such an event, the core service portion of the service routine corresponding to the peripheral device that asserted the first interrupt request signal is interrupted so that the service routine corresponding to the highest priority device can be executed. Preferably, interrupt requests on the shared interrupt request line will be masked during execution of this higher priority service routine so that the execution may not be interrupted. Upon completion of the higher priority service routine, execution of the prior service routine, which was interrupted, is resumed. In this manner, the interrupt latency of the highest priority device is reduced when another peripheral device has asserted a prior interrupt request that hasn't been completely serviced. Additionally, the interrupt latency for the highest priority device is much more deterministic when compared with the prior art.

According to a second aspect of the invention, a method is defined that provides a way to prioritize the order in which service routines corresponding to peripheral devices are dispatched for execution. Upon receiving an interrupt request on a shared interrupt line, the device that asserted the interrupt will not be immediately known. In order to identify the asserting device, it is necessary to query the various devices to see which asserted the interrupt. This step is preferably performed through the execution of machine instructions corresponding to a peripheral device detection code segment of each service routine. Once the device that asserted the interrupt is identified, the core service portion of the service routine for that device can be promptly executed to service the interrupt request. The method enables a user to define an ordered chain corresponding to a desired order in which the service routines are to be executed. Preferably, the order will be defined so that the service routine corresponding to the highest priority device will be executed prior to any other service routine. If the highest priority device asserts an interrupt request, the highest priority device will be identified as the device that asserted the request (through the peripheral device detection code segment of its corresponding service routine), and its service routine will be executed without requiring any portion of the other service routines to be executed, thereby reducing interrupt latency for the highest priority device. Preferably, the ordered chain is defined in a data structure that includes pointers to the memory locations of the service routines and data identifying whether a particular service routine corresponds to the highest priority device.

According to a further aspect of the present invention, a computing apparatus is provided for implementing the method. The apparatus includes a memory for storing machine instructions, which is coupled to a processor for executing the instructions, and has a shared interrupt request line to which a plurality of peripheral devices are connected. Each peripheral device has a corresponding service routine stored in the memory, preferably comprising a portion of a device driver that is loaded into the memory when an operating system of the computing apparatus is booted. The operating system includes an interrupt handler and dispatch component that controls the handling of various interrupt requests, and includes the data structure that defines the chained order in which the service routines are to be executed. Preferably, the apparatus further includes a PIC that enables interrupt requests to be selectively masked and unmasked, thereby enabling the highest priority device to interrupt execution of a service routine corresponding to a non-highest priority device, while preventing other interrupt requests from being processed while the highest priority device is being serviced.

### BRIEF DESCRIPTION OF THE DRAWING FIGURES

The foregoing aspects and many of the attendant advantages of this invention will become more readily appreciated as the same becomes better understood by reference to the following detailed description, when taken in conjunction with the accompanying drawings, wherein:

FIG. 1 is a table of data identifying various interrupts, corresponding interrupt request numbers, and common uses for the interrupts, in a typical PC;

FIG. 2 is a schematic diagram illustrating how interrupt request lines are mapped to PICs using a wired-OR'ed scheme;

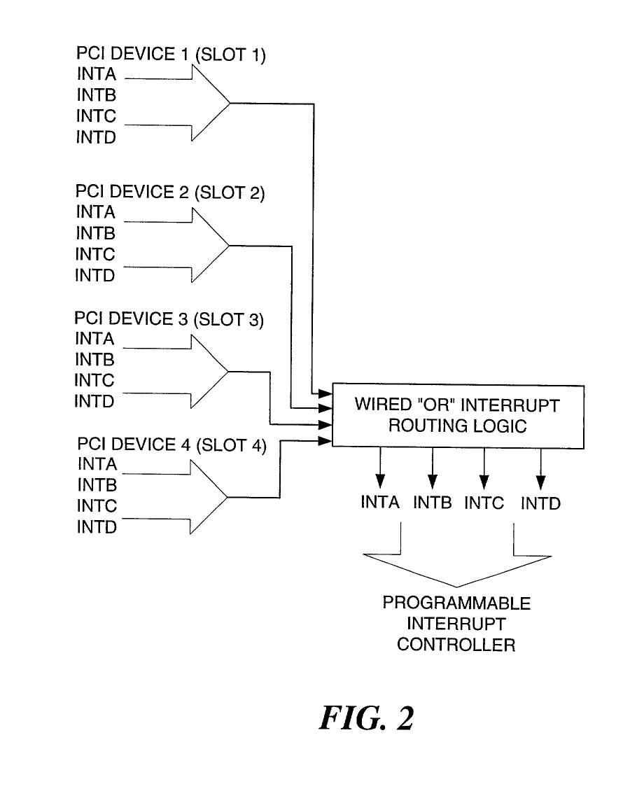

FIG. 3 is a table showing an exemplary recommended scheme for mapping physical interrupt lines to programmable interrupt request signals on Intel Corporation's PENTIUM™-based computers that employ Intel Corporation's DK440LK™ chipset;

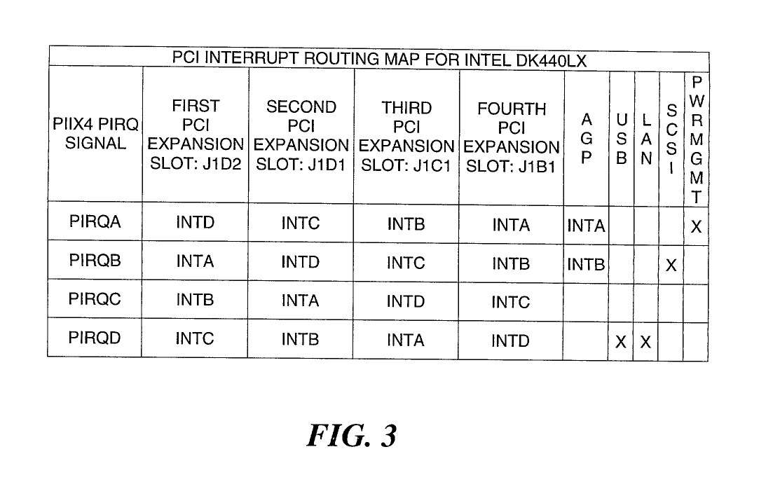

FIG. 4 is a schematic block diagram illustrating the internal architecture of a typical PIC;

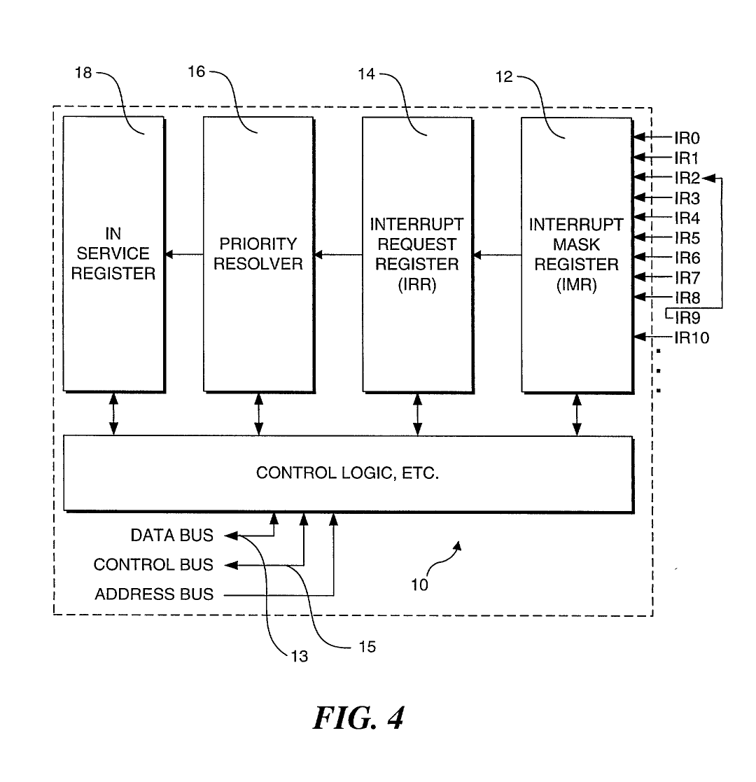

FIG. 5 is a schematic block diagram illustrating how an interrupt is handled in computing apparatus that employs Microsoft Corporation's WINDOWS CE™ operating system;

FIG. 6 (Prior Art) is a schematic block diagram illustrating a conventional scheme for handling an interrupt request on a shared interrupt request line under Microsoft Corporation's WINDOWS CE™ operating system;

FIG. 7 is a schematic block diagram illustrating how the present invention handles an interrupt request on a shared interrupt request line under Microsoft Corporation's WINDOWS CE™ operating system;

FIG. 8 is a logic flow chart illustrating the logic used by the present invention when handling an interrupt request on a shared interrupt line;

FIGS. 9A and 9B are timelines corresponding to the handling of an exemplary interrupt request sequence, wherein FIG. 9A corresponds to a conventional interrupt handling scheme and FIG. 9B corresponds to the interrupt handling scheme of the present invention; and

FIG. 10 is a block diagram of a typical PC system suitable for use in implementing a preferred embodiment of the present invention.

### DESCRIPTION OF THE PREFERRED EMBODIMENT

The present invention provides a method for prioritizing the handling of interrupt requests from peripheral devices that share an interrupt request line by defining a protocol between the interrupt service routines and the operating system interrupt exception and dispatch code. In the following description of a preferred embodiment of the invention, the invention is described in the context of using the invention with Microsoft Corporation's WINDOWS CE™ operating system (OS) on a computing apparatus that employs the PCI bus. This description of a preferred embodiment is not meant to be limiting of the scope of the invention, as it will be understood by those skilled in the art that the principles of the present invention as described below may be applied to other operating systems and bus architectures that use shared interrupt requests lines so that interrupt requests from peripheral and other devices that share an interrupt request line may be selectively prioritized in a desired manner.

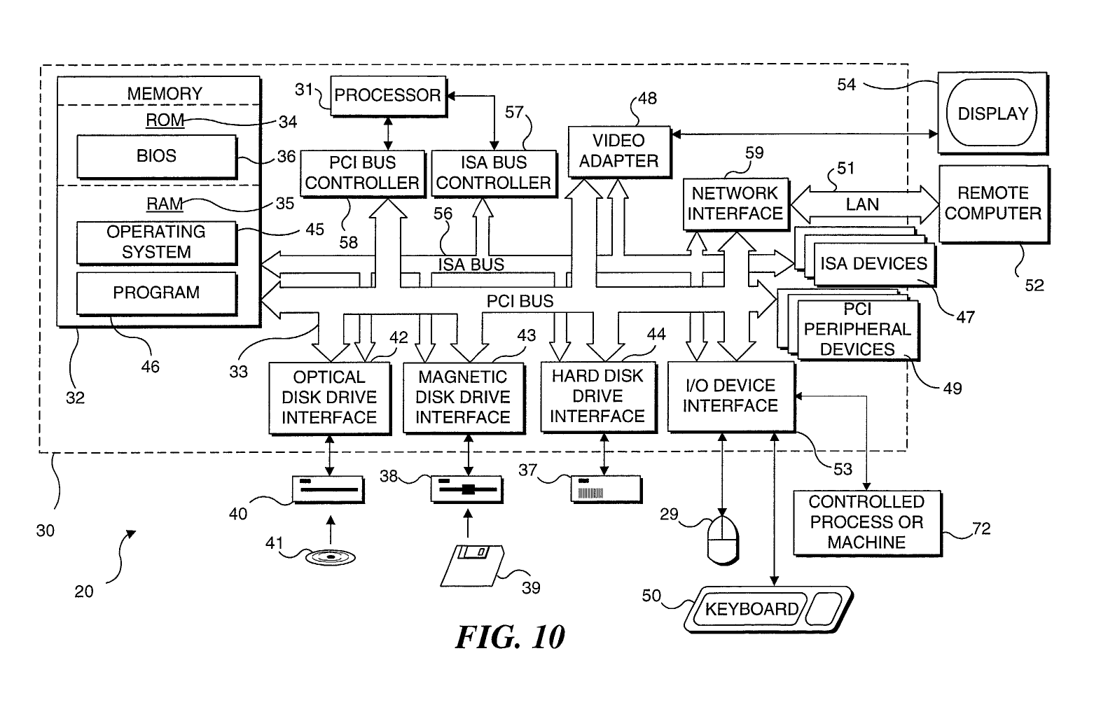

In FIG. 10, an exemplary PC system 20 with which the present invention may be used includes a central processing unit (CPU) card 30 (which may be a motherboard) that includes a CPU 31, a memory 32, an ISA bus 56, and a PCI bus 33. A PCI bus controller 58 and an ISA bus controller 57 are employed by processor 31 to monitor and control PCI bus 33 and ISA bus 56, respectively. In fact, most newer PCI bus controls implement the ISA bus behind the PCI bus, so processor 31 accesses the ISA bus via the PCI bus controller (via an ISA-to-PCI bridge), but, for simplification, separate ISA and PCI bus controllers are shown in the Figure. Also, some new PCs do not include “legacy” components, such as an ISA bus.

Memory 32 includes read only memory (ROM) 34 and random access memory (RAM) 35. The basic routines that are employed to transfer information between the components of CPU card 30 are implemented by a BIOS 36, which is stored in ROM 34. An operating system 45 and a software program 46 are loaded into RAM 35. In one preferred embodiment, Microsoft Corporation's WINDOWS CE operating system 45 is employed; however, as noted above, the present invention is not limited to use with this operating system. Certain aspects of the present invention are implemented by operating system 45 using a plurality of routines provided by software program 46. Other programs that may also be loaded into RAM 35 include device drivers that are associated with devices coupled to CPU card 30 through either ISA bus 56 or PCI bus 33, such as ISA devices 47 and PCI peripheral devices 49, respectively. Each device driver may manage an interrupt asserted by its associated device.

CPU card 30 is optionally connected to a hard disk drive 37. Although not required, the CPU card may also be coupled to other nonvolatile storage devices, such as a magnetic disk drive 38, and/or an optical disk drive 40. If provided, these nonvolatile storage devices are coupled to either PCI bus 33 or ISA bus 56 by a hard disk drive interface 44, a magnetic disk drive interface 43, and an optical disk drive interface 42, respectively. Magnetic disk drive 38 is employed for reading and writing to a removable magnetic disk 39. Also, optical disk drive 40 provides for reading from or writing to a removable optical disk 41, such as a CD-ROM or other optical media. The drives and their associated media provide for the nonvolatile storage of computer readable instructions, and other data for use by CPU card 30. In the preferred embodiment, different types of data may be stored on hard disk 37, magnetic disk 39, and optical disk 41, or in ROM 34, or RAM 35. Furthermore, other types of media, such as magnetic cassettes and flash memory cards (not shown), may be employed by CPU card 30 for storing data and/or machine instructions or programs.

A user of CPU card 30 may employ input devices such as a pointing device (e.g., a mouse) 29 and a keyboard 50, to provide input of commands and/or data. Although not shown, other types of input devices may also be employed with CPU card 30, including a microphone, joystick, game pad, satellite dish, and scanner. An input device is coupled by an input/output (I/O) device interface 53 to processor 31 through either PCI bus 33 or ISA bus 56. A plurality of I/O device interfaces (not separately shown) may be employed to provide various ports, such as serial, parallel, game, small computer systems interface (SCSI), universal serial bus (USB), and FireWire (a port meeting the IEEE 1394 specification), for connecting different types of input/output devices to CPU card 30. For instance, a controlled process or machine 72 may be coupled to a port using an appropriate input/output (I/O) interface. Also, interfaces for one or more analog-to-digital converters (ADCs), digital-to-analog converters (DACs), digital input/output, encoders, video frame grabbers, and other equipment that might be used in a process may optionally be included. A display 54 is connected to CPU card 30 through a video adapter 48 that is coupled to processor 31 through either PCI bus 33 or ISA bus 56.

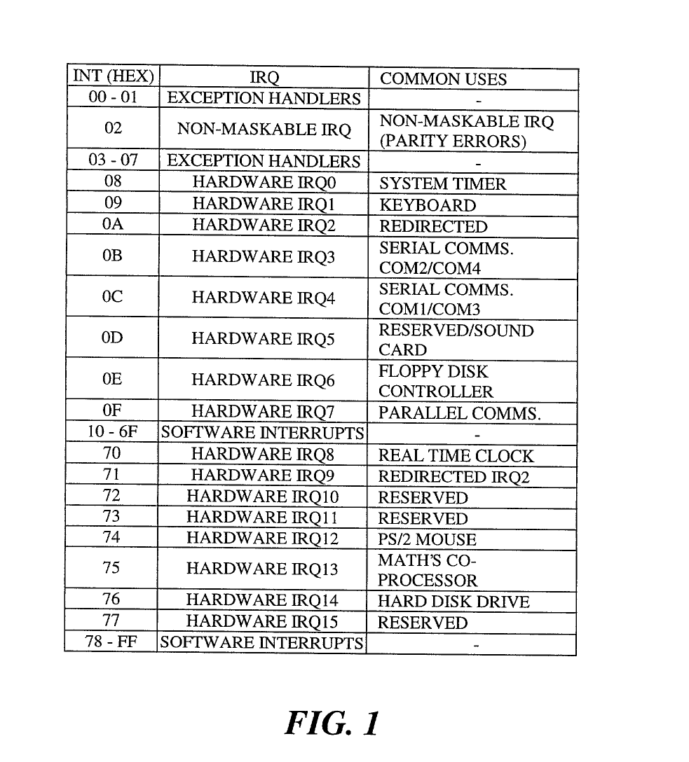

In FIG. 1, CPU card 30 is shown operating in a networked environment that employs logical connections to one or more remote computers, such as a remote computer 52, which may be a server, a router, a network PC, or another CPU card, and typically will include many of the elements described above that are provided on or connected to CPU card 30. A network interface 59 is coupled to processor 31 through either ISA bus 56 or PCI bus 33. Network interface 59 is also coupled through a local area network (LAN) 51 to remote computer 52. LAN 51 is employed to provide a logical connection between CPU card 30 and a networked environment that may include an office network, a wide area network (WAN), an intranet, and/or the Internet. In the networked environment, programs that are accessible by CPU card 30 may be stored in the memory of remote computer 52. Moreover, it will be appreciated by those skilled in the art that other means, such as a modem (not shown), may be employed to establish a logical connection through a WAN between CPU card 30 and remote computer 52.

WINDOWS CE™ balances performance and ease of implementation by breaking interrupt processing into two parts, a kernel-mode part and a user-mode part. The kernel-mode part is called performs overhead operations corresponding to the ISR, while the core of the ISR is performed by the user-mode part. Optionally, all of the ISR operations can be performed in the kernal-mode part. The kernal-mode part of the ISR resides in an OEM adaptation layer (OAL) of the operating system and has direct access to hardware registers. Its sole job is to determine the interrupt identifier to return to the kernel interrupt handler, thereby mapping physical IRQs onto logical interrupts. WINDOWS CE™, like other WINDOWS™ operating systems, uses a multithreaded preemption scheme comprising multiple priority levels, whereby the higher priority threads may preempt execution of lower priority threads that were originally scheduled to execute first.

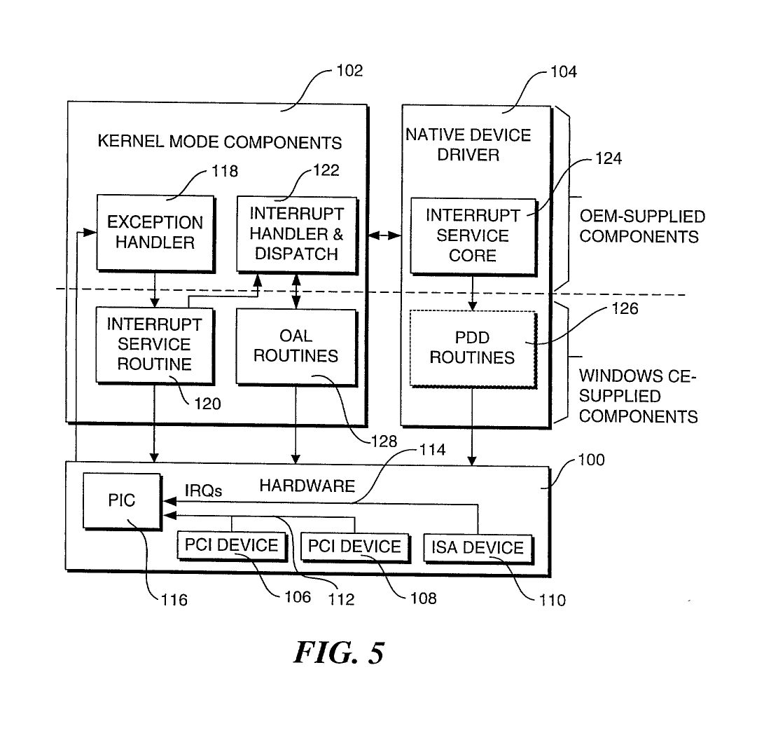

An overview illustrating the interaction between various components of the WIDOWS CE™ operating system (OS) when handling interrupts is shown in FIG. 5. At a top level, the interrupt handling process comprises system hardware 100, a portion of the OS kernel 102, and a native device driver 104. The process begins when one of PCI devices 106 or 108, or ISA device 110 (if a dual bus architecture is supported) asserts a request for interrupt servicing by activating an IRQ line connected to either a PCI bus 112, or an ISA bus 114, as appropriate. Activation of the IRQ line is asserts an IRQ onto a PIC 116, which produces an interrupt exception signal that is supplied to an exception handler 118. Exception handler 118 resides in a layer of the kernel portion of the OS that is accessible to developers (e.g., OEMs, etc.), and comprises programming code that enables the operating system to handle various exception events, including interrupts. The exception handler disables all interrupts at PIC 116 and calls the appropriate ISR (represented by a block 120) for the physical IRQ line on which the interrupt request was asserted, which is typically identified by reading the PIC's interrupt request register. The ISR returns a logical interrupt, in the form of an interrupt identifier, to an interrupt handler 122. The interrupt handler comprises dispatch code that sets an event that causes the processor to begin executing a waiting ISR core 124. ISR core 124 comprises instructions for servicing the hardware device that asserted the IRQ, and such servicing is performed by calling routines in a Platform Dependent Driver (PDD) layer 126 to communicate with and service the hardware device. Alternately, the ISR core may directly communicate with the hardware device if native device driver 104 comprises a monolithic driver architecture. Upon completion of its service routine, the ISR calls an InterruptDone function. Control is then returned to interrupt handler 122, which re-enables the current interrupt and calls the OEMInterruptDone function in an OEM extraction layer (OAL) 128 of kernel 102.

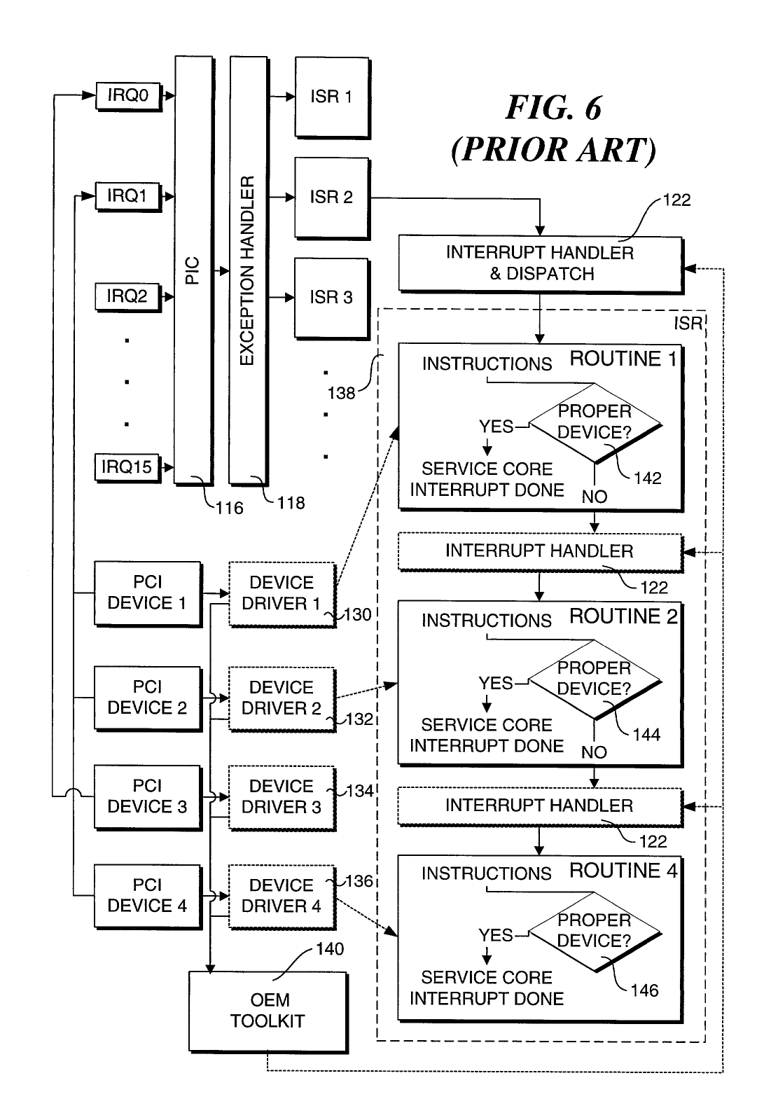

While the two-part interrupt handling scheme provided by WINDOWS CE™ simplifies some aspects of handling interrupts, it makes handling shared IRQs rather difficult. As shown in FIG. 6, which illustrates a typical scheme for handling shared interrupts under WINDOWS CE™, a shared interrupt problem is created when two or more PCI devices (e.g., PCI devices 1, 2, and 4) are wired-OR'ed to the same physical IRQ line (e.g., IRQ1, as shown in the Figure). When each PCI device is installed into a system, a corresponding device driver is also generally installed, such as device drivers 130, 132, 134, and 136. The device drivers for most PCI devices are similar to the native device driver discussed above, although other types of device drivers are also supported. In the context of the discussion of FIG. 5 above, each device driver, if examined independently, performs the function of ISR core 124 and comprises a particular set of machine instructions for servicing the driver's corresponding device. Under WINDOWS CE™, device drivers typically comprise dynamic link libraries (DLLs).

Registration of the ISRs enables the OS's interrupt handler to know the location of the various ISRs and provides a scheme for handling multiple ISRs that are assigned to the same logical interrupt. For example, in a computer running WINDOWS 98, several PCI devices might be assigned to IRQ11, so that each of the devices have a registered device driver, and the interrupt handler is notified of the location of each of the device's corresponding ISR. The interrupt handler can then “walk” the ISRs for a given IRQ until an appropriate ISR (corresponding to the PCI device requesting service) is executed to service the interrupt request.

Rather than enable registration of multiple ISRs in the manner described above, WINDOWS CE™ allows assignment of only a single ISR for each logical interrupt. This limitation poses a problem when multiple devices (and therefore device drivers) are mapped to the same logical interrupt, because the interrupt handler can only be mapped to one ISR, and each device driver comprises an ISR. This problem is handled through use of a specially adapted OEM toolkit 140, which enables interrupt handler 122 to call appropriate service routines that perform functions similar to those performed by the ISRs. These service routines collectively comprise a “pseudo” ISR, such as an ISR 138 in FIG. 6.

ISR 138 comprises three service routines, namely routine 1, routine 2, and routine 4. Each of routines 1, 2, and 4 comprises instructions for servicing an interrupt request asserted by a corresponding PCI device, as follows. Routine 1 services PCI device 1; routine 2 services PCI device 2; and routine 4 services PCI device 4. The code for each of these routines is stored in memory, and comprises a portion of each PCI device's respective device driver. OEM toolkit 140 enables ISR 138 to be written so that interrupt handler 122 can identify the starting memory address of each of routines 1, 2, and 4.

When any of PCI devices 1, 2, or 4 asserts an interrupt request, the request is mapped to IRQ1, and this IRQ is received as an input by PIC 116. PIC 116 then informs exception handler 118 that an interrupt request has been asserted, and exception handler 118 identifies the IRQ (IRQ1 in this case) to which the interrupt request corresponds, by reading the interrupt request register in PIC 1 18. Exception handler 118 then disables all interrupts at PIC 116 and calls ISR 2, the interrupt service routine corresponding to interrupt requests that are physically mapped to IRQ1. ISR 2 returns a logical interrupt to interrupt handler 122, which causes execution of an appropriate interrupt service routine for servicing the device that asserted the IRQ.

In response to receiving the logical interrupt, interrupt handler 122 dispatches execution of the service routines (i.e., routines 1, 2, and 4) in the following manner. Through use of a pointer, the first instruction of the first routine (routine 1 in the Figure) is dispatched for execution subsequent instructions of the first routine are executed in order. Preferably, a code segment will be located near the start of each routine to determine if the routine's corresponding PCI device asserted the interrupt request. These code segments are indicated by a decision block 142 in routine 1, a decision block 144 in routine 2, and a decision block 146 in routine 4. The code segments corresponding to each of decision blocks 142, 144, and 146 comprise instructions that determine if their respective device has asserted an interrupt. For example, when each of PCI devices 1, 2, and 4 are installed, their corresponding device drivers 1, 2, and 4 are also installed. As discussed above, included in each of these device drivers are instructions corresponding to a respective service routine. These device drivers also include information identifying the bus addresses of one or more state registers on each PCI device that are set when that PCI device asserts an interrupt service request.

For example, assume that PCI devices 1, 2, and 4 each have a respective state register 1, 2, and 4, with a corresponding respective bus address 1, 2, and 4. When the instructions corresponding to decision block 142 are executed in routine 1, state register 1 is read by loading bus address 1 on PCI bus 112. If PCI device 1 asserted the interrupt request, then state register 1 will be set, and the answer to decision block 142 will be true (yes), causing the core interrupt service instructions (i.e., the plurality of instructions that perform the task of servicing a device, once the device has been identified) of routine 1 to be executed. Thus, in this case, PCI device 1 will be serviced. Upon completion of routine 1, the InterruptDone function will be called, and control will be returned to interrupt handler 122, which re-enables the current interrupt and calls the OEMInterruptDone function, thereby completing the interrupt request.

As described thus far, the shared interrupt scheme does not appear to present much of a problem. However, assume that the device asserting the interrupt was not PCI device 1, but instead, was PCI device 4. In this case, decision block 142 will produce a negative result, and routine 1 will return control back to interrupt handler 122 with a return value indicating that the interrupt has not been handled. Interrupt handler 122 will cause execution of the next service routine (routine 2 in this case) by passing a pointer to the location of the starting address of the next service routine, and execution of the instructions of that service routine will begin.

Shortly after beginning execution of routine 2, the code segment of routine 2 corresponding to decision block 144 will be executed to determine whether PCI device 2 asserted the interrupt request. Execution of this code segment will check state register 2 by asserting address 2 on PCI bus 112. Since PCI device 2 did not assert the interrupt request, the result in decision block 144 is negative, and control is returned to interrupt handler 122, with a return value indicating that the interrupt request was not handled. The interrupt handler will then provide a pointer to the first instruction of the next service routine (in this case routine 4), and execution of the instructions in that routine will begin.

Once again, shortly after routine 4 begins execution, the code segment corresponding to decision block 146 will be executed, which will check state register 4 by asserting address 4 on PCI bus 112 to determine if PCI device 4 asserted the interrupt request. In this case, state register 4 will be set (since PCI device 4 asserted the interrupt), and the response in decision block 146 will be affirmative. As a result, the core service routine instructions for servicing PCI device 4 will be executed, state register 4 will be cleared, the InterruptDone function will be called, and completion of the interrupt service process will pass back to interrupt handler 122.

Notice that in the foregoing example, a substantial number of instructions must be executed before the core service routine corresponding to the device actually requesting the interrupt began executing. Execution of these instructions increases interrupt latency, thereby decreasing performance. Also note that the interrupt latency for a particular PCI device will be non-deterministic, unless the order of routines 1, 2, and 4 are known. In general, the order in which routines 1, 2, and 4 are dispatched for execution will depend on the order in which the PCI devices corresponding to these routines were added to the system. As a result, the interrupt latency for devices at the end of the chain may be excessively long.

Another significant problem with the foregoing conventional interrupt-handling scheme is that is does not provide a way for prioritizing devices that share an interrupt. Since the IRQ (e.g., IRQ1) corresponding to the interrupt request is masked during execution of the service routines comprising ISR core 138, it is not possible for any PCI devices that share that IRQ line to have an interrupt request serviced prior to the completion of ISR core 138. In other words, once the interrupt service corresponding to any of PCI device 1, 2, and 4 begins, any subsequent interrupt request by any of the remaining PCI devices that share the same IRQ line will be blocked until the original interrupt service is completed. As a result, in the prior art technique, it is not possible to prioritize interrupt servicing of PCI devices that share the same IRQ line.

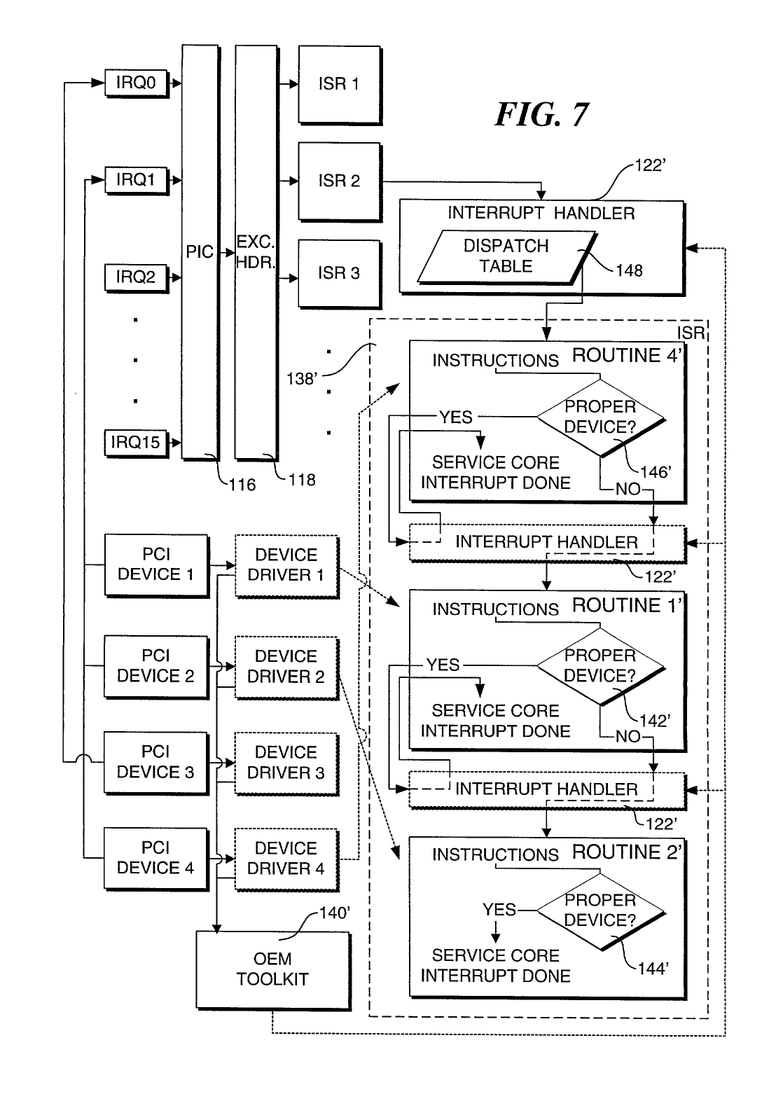

This problem is addressed by the present invention through the use of a modified interrupt service handler 122′ that includes a dispatch table 148, as shown in FIG. 7. Both interrupt service handler 122 and dispatch table 148 are generated through the use of an improved OEM toolkit 140′, based on user input and information contained in device drivers 1, 2, and 4.

A dispatch table 148, in conjunction with interrupt service handler 122′, provides a priority mechanism that enables a user to specify one PCI device from among a group of PCI devices that share an IRQ line, to have a highest priority. The selected PCI device identified as having the highest priority can then interrupt a service routine that is executing for any of the other PCI devices. Dispatch table 148 includes a plurality of data structures, each corresponding to a particular PCI device that shares an IRQ line. An exemplary data structure is shown below.

struct INTERRUPT_DISPATCH {

INTERRUPT_FUNCTION *pIsr; // pointer to the interrupt

function

INTERRUPT_DISPATCH *pNextIsr; // pointer to the next

interrupt in the chain

BOOLEAN HighPriority; // is this the high priority interrupt in the

chain

}

The data structure comprises a pointer to a corresponding service routine (*pIsr), a pointer to the next service routine in the chain (*pNextIsr), and a Boolean value indicating whether the corresponding PCI device is defined to be the highest priority device.

In addition to being able to select a highest priority device, the present invention ensures that the service routine corresponding to that device is executed before the service routine corresponding to any other PCI device is executed. This ordering of service routines is handled by the OEM toolkit, which enables the service routine corresponding to the selected PCI device to be placed at the top of the chain using the data structure.

Routines 1′, 2′, and 4′ are substantially similar to routines 1, 2, and 4, respectively. In addition, decision blocks 142′, 144′, and 146′ perform functions substantially similar to those of respective decision blocks 142, 144, and 146, as discussed above.

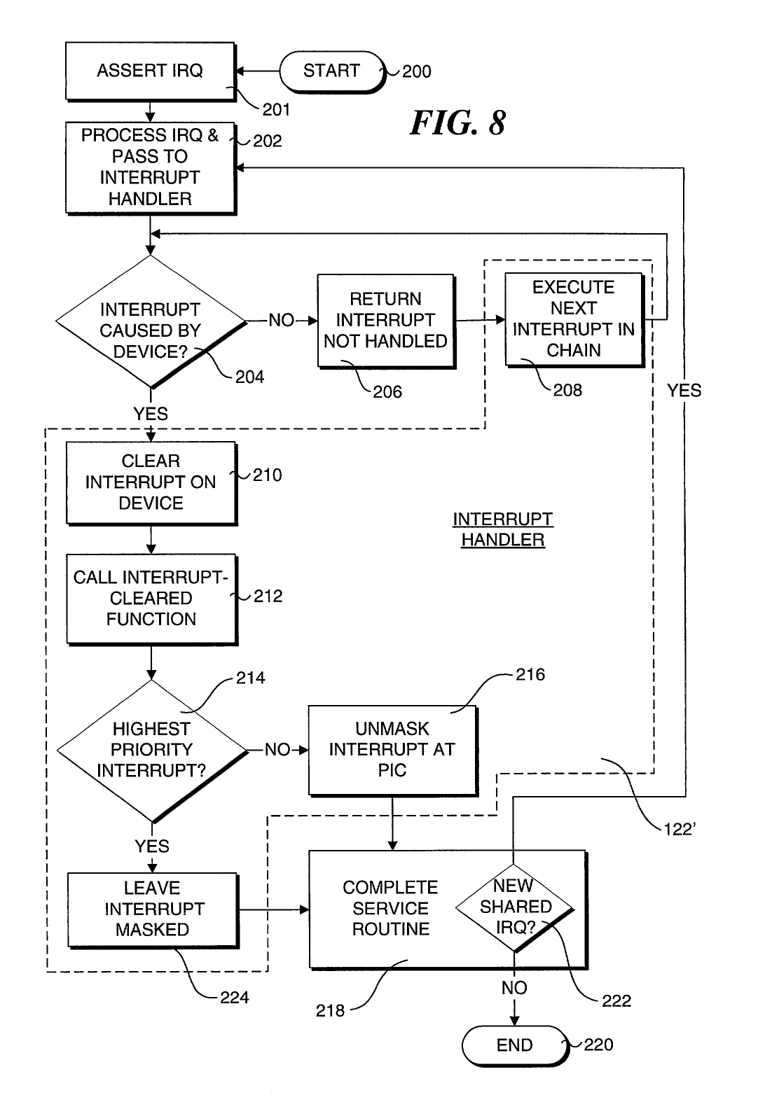

With reference to FIG. 8, an exemplary handling of shared interrupt requests in accord with the present invention, using the system of FIG. 7, is performed as follows. In this example, PCI device 4 is selected to be the highest priority device, while PCI devices 1 and 2 are lower priority devices. Accordingly, the data structures in Dispatch table 148 are formulated such that routine 4′, the service routine corresponding to PCI device 4, is executed first. The order of execution of routines 1′ and 2′ is not of particular importance—for convenience, these routines are executed in their numerical order, but they can be executed in the opposite order.

The process shown in FIG. 8 begins in a start block 200 and proceeds to a block 201 in which an interrupt request is asserted on shared IRQ line IRQ1 by one of PCI Devices 1, or 2. Next, in a block 202, the interrupt request is handled by PIC 116, exception handler 118, and ISR 2 of FIG. 7, in a manner generally similar to that discussed above with reference to the conventional scheme of FIG. 6, thereby masking IRQ1 and passing a logical interrupt to interrupt handler 122′. Upon identification of the logical interrupt, interrupt handler 122′ causes execution of the first instruction of routine 4′, so that a code segment corresponding to a decision block 146′ in FIG. 7 is executed. The function performed by decision block 146′ is in accord with a decision block 204 in the flow chart of FIG. 8. In a manner similar to that discussed above with reference to decision block 146, decision block 146′ (and, accordingly, decision block 204) determines if the interrupt request was asserted by the PCI device associated with decision block 146's service routine (i.e., PCI device 4). In this case, the answer is no, and the logic flows to a block 206 in FIG. 8, in which a value is returned to interrupt handler 122′, indicating that the interrupt was not handled. Interrupt handler 122′ then directs execution (via a pointer in dispatch table 148) of the next service routine in the chain, as indicated by a block 208. In this case the next service routine in the chain is routine 1′ in FIG. 8.

Execution of routine 1′ begins and proceeds to a code segment corresponding to a decision block 142′ in FIG. 7. In accord with the flow chart of FIG. 8, the logic loops back to decision block 204. As before, decision blocks 142′ and 204 (in FIGS. 8 and 7, respectively) determine if the device that asserted the interrupt corresponds to the presently executing service routine, which in this case, is routine 1′. Assume that PCI device 1 asserted the interrupt. In this instance, the answer to both of decision blocks 142′ and 204 is yes, and control passes back to interrupt handler 122′, so that the interrupt on the device is cleared in a block 210 (e.g., by clearing an appropriate state register on PCI device 1); an InterruptCleared function is called in a block 212. Instructions corresponding to the InterruptCleared function comprise a portion of the exception code of interrupt handler 122′.

In accord with a decision block 214, upon receiving the InterruptCleared function call, interrupt handler 122′ checks dispatch table 148 to determine if the device that asserted the interrupt request is the highest priority device. In this case, since the interrupt request was asserted by PCI device 1, which is not the highest priority device, the logic flows to a block 216 in FIG. 8, in which the shared IRQ line (i.e., IRQ1) is unmasked at PIC 116. Notably, this allows subsequent interrupt requests asserted on the shared IRQ line to be acknowledged and serviced prior to the completion of the present interrupt service, as described in further detail below. After the shared IRQ line is unmasked, control is returned to the previously-executing service routine (e.g., routine 1 here), and the instructions comprising the core service portion of the service routine are, executed to complete the service request in a block 218 in FIG. 8.

In accord with a decision block 222, if there is not any new interrupt request asserted on the shared interrupt request line (e.g., an interrupt asserted by any of PCI devices 1, 2, or 4 on IRQ1) during execution of the service core portion of routine 1, the service routine is completed, an InterruptDone call is made, control is returned to interrupt handler 122, and all IRQs are unmasked at PIC 116. These steps completes servicing of the interrupt request, as indicated by an END block 220.

Assume now that a new interrupt request is asserted by either of PCI devices 2 or 4 during execution of the service core segment of routine 1′. (Note that in a well-designed system, any device that asserts an IRQ will not assert another IRQ until the first IRQ is serviced—therefore PCI device 1 should not be able to assert an IRQ in this instance.) As discussed above, since IRQ1 was unmasked in block 216, execution of routine 1′ can be interrupted by subsequent interrupt requests on IRQ1. As a result of the asserted interrupt request, the answer to decision block 222 is yes, causing the logic to flow back to block 202. In a manner similar to that described above, the IRQ will then be processed by PIC 116 and exception handler 118, IRQ1 will be masked, and a logical interrupt will be passed to interrupt handler 122′, which then dispatches execution of routines 4′, 1′, and 2′ in order, as necessary.

Suppose that the device that asserted the new interrupt request is PCI device 4, the highest priority device. In this case, when execution flows to decision block 204 (and, accordlingly, decision block 146′ in routine 4), the answer to the decision block is yes, and the logic flows to blocks 210 and 212, returning control to interrupt handler 122, the interrupt is cleared on PCI device 4 and the InterruptCleared function is called. This time, when the InterruptCleared function is executed, the answer to decision block 214 is yes, since the device that asserted the new IRQ is the highest priority device. As a result, the logic flows to a block 224, which leaves the IRQ line (i.e., IRQ1) masked. The logic then flows to block 218, where the service core portion of routine 4′ is executed to complete service of the interrupt request. Note that in this instance, since IRQ1 is masked, the answer to decision block 222 will always be no. As a result, the service routine corresponding to the highest priority device that shares an IRQ line cannot be interrupted by any other device that shares that IRQ line. Also note that the system and method of the present invention allows an IRQ asserted by a device designated to have the highest priority to interrupt any presently-executing service routine corresponding to an IRQ asserted by a lower priority device that shares an IRQ line with the highest priority device.

In the remaining case, assume that the device asserting the new interrupt request is PCI device 2. In this instance, the answer to decision block 222 is yes, and the logic flows back to block 202, where the interrupt request is processed in a manner similar to that described above, resulting in a logical interrupt being passed to interrupt handler 122′. Interrupt handler 122′ then dispatches execution of routine 4′. The answer to decision block 146′ (and, accordingly, decision block 204) will be no, a value will be returned to interrupt handler 122′ indicating that the interrupt was not handled, and execution will be passed to the beginning of the next service routine in the chain, which is routine 1′. As routine 1′ executes, the answer to decision block 142′ (and, accordingly, decision block 204) will be no, a value will be returned to interrupt handler 122′ indicating that the interrupt was not handled, and execution will be passed to the beginning of the next service routine in the chain, in this case routine 2′. Since routine 2′ corresponds to the device that asserted the interrupt request (i.e., PCI device 2), the answer to decision block 144′ (and, accordingly, decision block 204) will be yes. Control will then pass back to interrupt handler 122, and functions corresponding to blocks 210 and 212 will be performed, thereby clearing the interrupt on PCI device 2, and calling the InterruptCleared function. The logic will then flow to decision block 214, which will produce a no result since PCI device 2 is not the highest priority device, and IRQ1 will be unmasked at PIC 116. At this point, the logic loops back to block 218, and the service core portion of routine 2′ is executed to completion (assuming that a new interrupt request is not asserted by the highest priority device (i.e., PCI device 4)).

After execution of routine 2′ is completed, control is returned to interrupt handler 122′, and IRQ1 is unmasked at PIC 116. At this point, execution returns to the portion of code that was executing prior to being interrupted by the new IRQ—that is, the service core portion of the previously executing service routine (i.e., routine 1′). This service core portion is completed, and control is returned to interrupt handler 122′, which again unmasks IRQ1 at PIC 116.

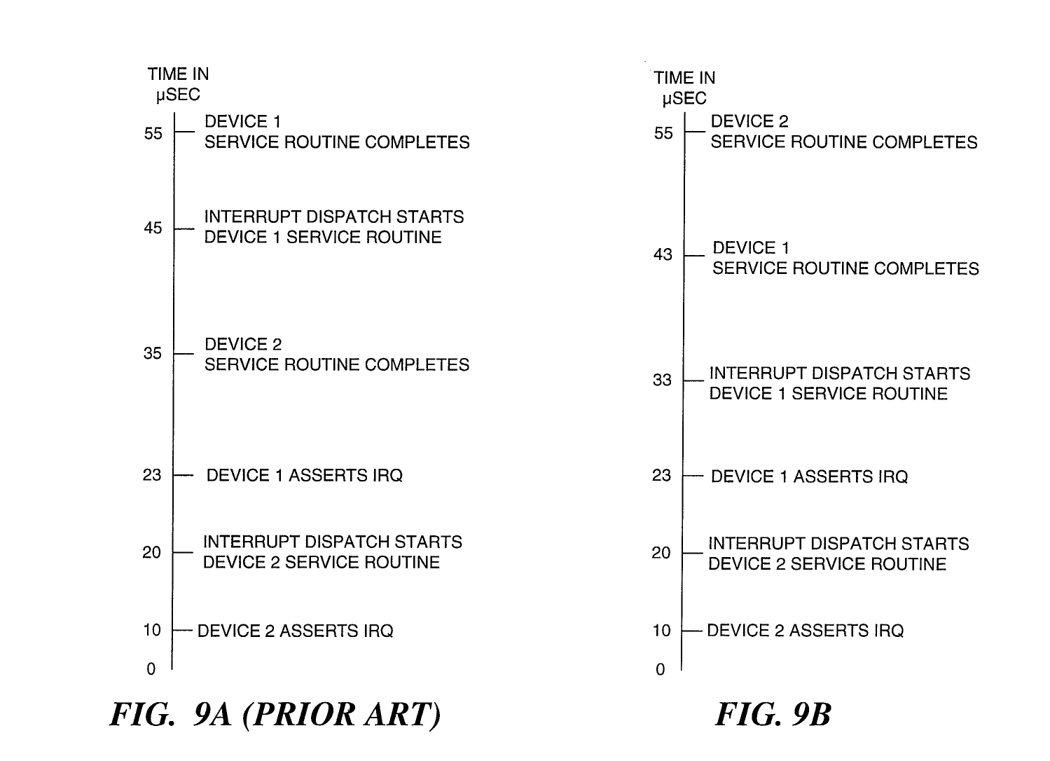

The timelines in FIG. 9A and 9B graphically illustrate the improvement provided by the present invention. These timelines correspond to the handling of an exemplary pair of interrupts asserted by two devices (a Device 1 and a Device 2) that share a common interrupt request line. The timeline in FIG. 9A corresponds to the prior art interrupt handling scheme, and the timeline in FIG. 9B corresponds to the scheme used in the present invention. Device 1 requires low latency interrupts and is therefore selected to be the highest priority device among the two devices. The service routine for Device 1 takes approximately 10 μsec to execute, while the service routine for Device 2 takes approximately 15 μsec to execute. Each system takes about 10 μsec to dispatch an interrupt.

In each of the timelines, Device 2 asserts a first interrupt request, which is acknowledged after 10 μsec. This interrupt request is processed, and a service routine for servicing the interrupt request is dispatched by the interrupt handler at the 20 μsec mark. At the 23 μsec mark, Device 1 asserts a second interrupt request on the shared interrupt request line. Under the prior art scheme, service routines corresponding to devices that share an interrupt request line cannot be interrupted by a subsequent interrupt request on the shared line. Therefore, once the service routine for Device 2 starts, it must run to completion, which takes approximately 15 μsec. Accordingly, under the prior art scheme, even though Device 1 asserted an interrupt request during execution of this service routine, processing of this latter interrupt request will not begin until the service routine for Device 2 is completed. As a result, the service routine for Device 1 will not be dispatched until 10 μsec after the completion of the service routine for Device 2, which corresponds to the 45 μsec mark. Device 1's service routine is then run to completion, which takes another 10 μsec, i.e., completing at the 55 μsec mark. The interrupt latency for Device 1, which is defined herein as the time between when an interrupt request is asserted and when the service routine for that interrupt request is dispatched, is equal to 45−23=23μsec under this prior art scheme.

As shown in the timeline of FIG. 9B, the interrupt latency for Device 1 is greatly reduced when using the interrupt handling scheme of the present invention. As discussed above, the present invention allows a highest priority device among devices that share an interrupt request line to be selected, and enables that device to interrupt execution of service routines corresponding to the other devices. Accordingly, when Device 1 asserts an interrupt request at the 23μsec mark, execution of Device 2's service routine is interrupted, and Device 1's interrupt request is processed, which takes approximately 10 μsec. At this point, corresponding to the 33 μsec mark, Device 1's service routine is dispatched and runs to completion. After the service routine for Device 1 is completed, execution of Device 2's service routine is resumed and run to completion. The interrupt latency for Device 1 using the present invention is 33−23=10 μsec.

The times used in FIGS. 9A and 9B are representative of interrupt handling time intervals on modern computer systems. The actual improvement achieved will depend on the particular hardware used, and other variables, included the length of the various service routines involved.

In addition to improving interrupt latencies, the present invention also reduces the effect of non-deterministic latencies. Notably, the interrupt latency for the highest priority device will be much more predictable than before, and should be very consistent and predictable when only interrupts from among a group of devices that share an interrupt request line are considered.

Although the present invention has been described in connection with the preferred form of practicing it, those of ordinary skill in the art will understand that many modifications can be made thereto within the scope of the claims that follow. Accordingly, it is not intended that the scope of the invention in any way be limited by the above description, but instead be determined entirely by reference to the claims that follow.

The invention in which an exclusive right is claimed is defined by the following:

1. A method of handling interrupts in a computing apparatus having a plurality of devices that share a shared interrupt request line, each of said plurality of devices having a corresponding service routine, including a core service portion comprising instructions for servicing the device in response to the device asserting an interrupt request signal on the shared interrupt request line, the method comprising the steps of:
(a) enabling one device among said plurality of devices to be selected as a highest priority device;
(b) asserting a first interrupt request signal on the shared interrupt request line with one of said plurality of devices;
(c) in response to step (b):
(i) determining a specific device among said plurality of devices that asserted the first interrupt request signal; and
(ii) initiating execution of the core service portion of the service routine corresponding to the device that asserted the interrupt request signal; and
(d) enabling execution of the core service portion initiated in step (c)(ii) to be interrupted in response to a subsequent interrupt request signal that is asserted on the shared interrupt request line by the highest priority device.

2. The method of claim 1, wherein the execution of the core service portion is only enabled to be interrupted in step (d) if the first interrupt request signal was not asserted by the highest priority device.

3. The method of claim 1, wherein the step of enabling comprises the steps of:
(a) masking the shared interrupt request line prior to performing step (c)(i) so that any subsequent interrupt requests asserted on the shared interrupt request line are not recognized while the shared interrupt request line is masked; and
(b) if it is determined that the device that asserted the interrupt request signal is not the highest priority device, unmasking the shared interrupt request line prior to initiating execution of the core service portion of the service routine.

4. The method of claim 1, wherein the first interrupt request signal is not asserted by the highest priority device, further comprising the steps of:
(a) asserting a second interrupt request signal corresponding to the highest priority device on the shared interrupt request line;
(b) interrupting execution of the core service portion of the service routine corresponding to the device that asserted the first interrupt request signal;
(c) executing the service routine corresponding to the highest priority device until it is completed; and
(d) then resuming execution of the core service portion of the service routine corresponding to the device that asserted the first interrupt request signal.

5. The method of claim 1, wherein each of said service routines further comprises a device detection portion that is executed prior to its core service portion when that service routine is dispatched for execution, said device detection portion comprising instructions for determining if that service routine corresponds to a device that has asserted an interrupt request signal on the shared interrupt request line.

6. The method of claim 1, wherein if the device that asserted the first interrupt request signal is the highest priority device, the service routine corresponding to the highest priority device is executed to completion regardless of any subsequent interrupt service request signals asserted on the shared interrupt request line.

7. The method of claim 1, further comprising the step of storing an identification of the highest priority interrupt service routine and a location of each service routine in a data structure.

8. The method of claim 7, wherein the data structure comprises data indicating an order in which said service routines are to be dispatched for execution on the computing apparatus, said order defining a chain of the service routines, such that the service routine corresponding to the highest priority device is dispatched first, and all other service routines are executed, as necessary, based on their respective order in the chain.

9. The method of claim 8, wherein each of said service routines further comprises a device detection portion that is executed prior to its core service portion when that service routine is dispatched for execution, said device detection portion comprising instructions for determining if that service routine corresponds to a device that has asserted an interrupt request signal on the shared interrupt request line.

10. The method of claim 9, wherein the device detection portions of each of said service routines are executed, as necessary, in sequential order based on a relative position of their corresponding service routine in the chain, until the service routine corresponding to the device that asserted the first interrupt service request is determined, whereupon execution of the core service portion of the service routine of the device that asserted the first interrupt service request is initiated for execution.

11. A method of handling interrupts in a computing apparatus having a plurality of devices that share a shared interrupt request line, each of said plurality of devices having a corresponding service routine including a core service portion comprising instructions for servicing the device in response to the device asserting an interrupt request signal on the shared interrupt request line, the method comprising the steps of:
(a) enabling one device among said plurality of devices to be selected as a highest priority device;
(b) indicating an order in which the service routines are to be dispatched for execution on the computing apparatus in response to an interrupt request signal being asserted on the shared interrupt request line, said order indicating that the service routine corresponding to the highest priority device is dispatched first, and that at least a portion of the other service routines are executed, as necessary, based on their respective positions in the order;
(c) asserting a first interrupt request signal on the shared interrupt request line with one of said plurality of devices;
(d) in response to step (c), initiating execution of at least one service routine on the computing apparatus, as necessary, based on the order of said service routines; and
(e) executing said at least one service routine that was initiated in step (d) on the computing apparatus, as necessary, until the device that asserted the first interrupt service request is serviced by its corresponding service routine.

12. The method of claim 11, wherein for each service routine that is executed, further comprising the steps of:
(a) determining if the service routine corresponds to the device that asserted the first interrupt request signal; and
(b) if it is determined that the interrupt service routine corresponds to the device that asserted the first interrupt request signal, completing execution of the service routine; else
(c) if it is determined that the service routine does not correspond to the device that asserted the first interrupt signal, initiating execution of a next service routine to service a next device in the order; and
(d) repeatedly applying the preceding three steps (a)-(c), until the device that asserted the first interrupt request signal is serviced.

13. The method of claim 11, further comprising the step of storing in a data structure the order in which the service routines are to be dispatched for execution on the computing apparatus in response to an interrupt request signal.

14. A computing apparatus comprising:
(a) a memory for storing a plurality of machine instructions;
(b) a shared interrupt request line;
(c) a plurality of devices connected to the shared interrupt request line, including a device that is selected to be a highest priority device;
(d) a respective service routine for each of said plurality of devices, each service routine comprising a portion of the plurality of machine instructions stored in the memory and including a core service portion comprising machine instructions for servicing a corresponding device in response to that device asserting an interrupt request signal on the shared interrupt request line; and
(e) a processor for executing the plurality of machine instructions stored in the memory, causing functions to be performed in response to a first interrupt request signal asserted by one of said plurality of devices on the shared interrupt request line, said functions including:
(i) determining a device from among said plurality of devices that asserted the first interrupt request signal;
(ii) dispatching execution by the processor of the machine instructions comprising the core service portion of the service routine corresponding to the device that asserted the interrupt request signal; and
(iii) enabling execution of the core service portion of the service routine to be interrupted in response to a subsequent interrupt request signal that is asserted on the shared interrupt request line by the highest priority device.

15. The computing apparatus of claim 14, wherein execution of the core service portion is enabled to be interrupted when function (e)(iii) is performed if the first interrupt request signal was not asserted by the highest priority device.

16. The computing apparatus of claim 14, further comprising a programmable interrupt controller connected in communication with the processor and the shared interrupt request line, wherein execution of the machine instructions by the processor further implements the functions of:
(a) masking the shared interrupt request line at the programmable interrupt controller so that any subsequent interrupt requests asserted on the shared interrupt request line are not recognized while the shared interrupt request line is masked; and
(b) if it is determined that the device that asserted the interrupt request signal is not the highest priority device, unmasking the shared interrupt request line at the programmable interrupt controller prior to initiating execution of the core service portion of the service routine corresponding to the device that asserted the interrupt request signal.

17. The computing apparatus of claim 15, wherein the first interrupt request signal is not asserted by the highest priority device, and further wherein execution of the machine instructions by the processor in response to a second interrupt request signal asserted by the highest priority device causes the processor to implement the functions of:
(a) interrupting execution of the core service portion of the service routine corresponding to the device that asserted the first interrupt request signal;
(b) executing the service routine corresponding to the highest priority device, until it is completed; and
(c) resuming execution of the core service portion of the service routine corresponding to the device that asserted the first interrupt request signal.

18. The computing apparatus of claim 14, further comprising a data structure, stored in the memory, said data structure defining an order in which the service routines are to be dispatched for execution on the computing apparatus in response to an interrupt request signal being asserted on the shared interrupt request line, said order ensuring that the service routine corresponding to the highest priority device is dispatched first, and at least a portion of other service routines are executed, as necessary, based on their respective order in the chain.

19. The computing device of claim 14, further comprising:
a plurality of device drivers, each corresponding to a respective device and comprising a portion of the plurality of machine instructions stored in the memory, at least a portion of each device driver comprising the machine instructions executed by the processor to implement the service routine corresponding to the respective device.

20. The computing device of claim 14, wherein the plurality of devices comprise at least two peripheral component interconnect (PCI) devices that are connected to a PCI bus, said PCI bus comprising a plurality of signal lines, including the shared interrupt request line.

21. The computing device of claim 14, wherein the plurality of devices comprise at least two compact peripheral component interconnect (compact PCI) devices that are connected to a compact PCI bus, said compact PCI bus comprising a plurality of signal lines, including the shared interrupt request line.
